(19) United States
(12) Patent Application Publication
(10) Pub. No.: US 2018/0338439 A1
(43) Pub. Date: Nov. 29, 2018

(54) Temperature and Light Insulated Aeroponics Root Chamber Built with Opaque High-Density Expanded Polypropylene

(71) Applicant: Wanjun Gao, Weston, FL (US)

(72) Inventor: Wanjun Gao, Weston, FL (US)

(21) Appl. No.: 15/604,722

(22) Filed: May 25, 2017

(51) Int. Cl. A01G 31/02

(52) U.S. Cl. CPC A01G 31/02

(57) ABSTRACT

The invention is a temperature and blight insulated aeroponics root chamber built with opaque High-Density EPP (Expanded Polypropylene). The chamber is a fully or partially enclosed container to host plant roots, to provide thermal insulation and light blockage functions, and to control humidity, temperature, and liquid leakage inside of the growth environment. The chamber may be produced with molding process to create seamless body construction, or may consist of multiple components. There are outlets and inlets through the chamber enclosure for the flows of nutrients and wastes. The chamber may contain one or more optional nutrient reservoirs. The chamber may be in different shapes and colors. The chamber may work with one or more temperature control devices.

### BACKGROUND

Aeroponics is the process of growing plants in an air or mist environment without the use of soil or an aggregate medium (known as geoponics). A root chamber is a container in which the nutrients are atomized into droplets and eventually delivered to roots. There are some challenges on the root chamber with aeroponics growing methods.

1. It is challenging to maintain a stable and desired temperature around roots.
Desired temperatures in root area offer benefits such as reducing plant stress, lowering harmful bacteria activities, and promoting healthy transpiration.
However, with aeroponics growing method, there is no wetted soil or large amount of water as a heat capacitor. The root area temperature will fluctuate during the day and the night, creating possible hazardous condition for plants.
Poor insulation between environment and root area usually result in the demand a lot of energies in order to maintain active temperature control.

2. Light penetration should be completely blocked in the root area to reduce or prevent algae growth, and to provide clean and controllable nutrient delivery environment.

3. As a root container, the chamber needs to be durable enough to maintain structure and surface integrity during the normal grow activities and the transportation process.

### BRIEF SUMMARY OF THE INVENTION

The invention is a temperature and light insulated aeroponics root chamber built with opaque High-density Expanded Polypropylene (EPP) to overcome the challenges mentioned above with aeroponics growing methods and to ensure stable, suitable, and durable plant growing environment.

Expanded polypropylene (EPP) is a foam form of polypropylene. EPP has very good impact characteristics thanks to its low stiffness. This allows a container made of EPP to resume its shape after impacts. EPP is extensively used in model aircraft and other radio controlled vehicles. it is mainly attributed to its ability to absorb impacts.

EPP foam also provides outstanding thermal insulation, making it an ideal material for temperature controlled storage for food and medical supplies.

Usage of EPP as the material for root chambers with aeroponics plant growing method has the following benefits:

1. EPP foam is a good thermal insulator. With proper insulation wall thickness, the chamber can insulate the root area from temperature fluctuation of its surroundings.

2. The insulation function passively maintains the temperature differences between the inside and the outside of the chamber. Therefore, it reduces energy required to maintain active temperature control.

3. Opaque High-density EPP can block light from getting in the root chamber.

4. High-density EPP is strong enough to handle transportation, and is flexible to embrace small impacts and restore to pre-impact condition.

5. PP (Polypropylene) as a material is relatively safe to human, and is widely used in food and medical industry. So EPP root containers are safe to grow vegetables, fruits and other edible plant in.

6. EPP material is more heat resistant and more fire retardant than many other common insulation materials such as EPS (expanded polystyrene).

7. The manufacturing process of EPP does not require blowing agents. Such agents often have negative environmental impacts.

8. EPP can be completely recycled, a process that is significantly less feasible for other insulation such as EPS (expanded polystyrene). That allows production and usage of EPP in mass scale to have less environments impact than those of other insulation materials.

In short, a root container made of EPP material is excellent in providing temperature insulation and light blockage. It is also strong, durable, safe and environment friendly.

There are no similar inventions to date. Existing aeroponics planting systems are mostly made with non-insulated plastics, multi-layer materials, or exposing the root to the surroundings without root chamber.

Compared to those systems, a root chamber made of opaque high-density EPP is easier to manufacture, and can provide a stable, safe, and controllable environment.

### BRIEF DESCRIPTION OF THE DRAWINGS

FIG. 1. illustrates a sample Opaque High-density EPP root chamber working with High-Pressure Aeroponics nutrient system.

FIG. 2. illustrates a sample Opaque High-density EPP root chamber with active temperature regulator.

### DETAILED DESCRIPTION AND BEST MODE OF IMPLEMENTATION

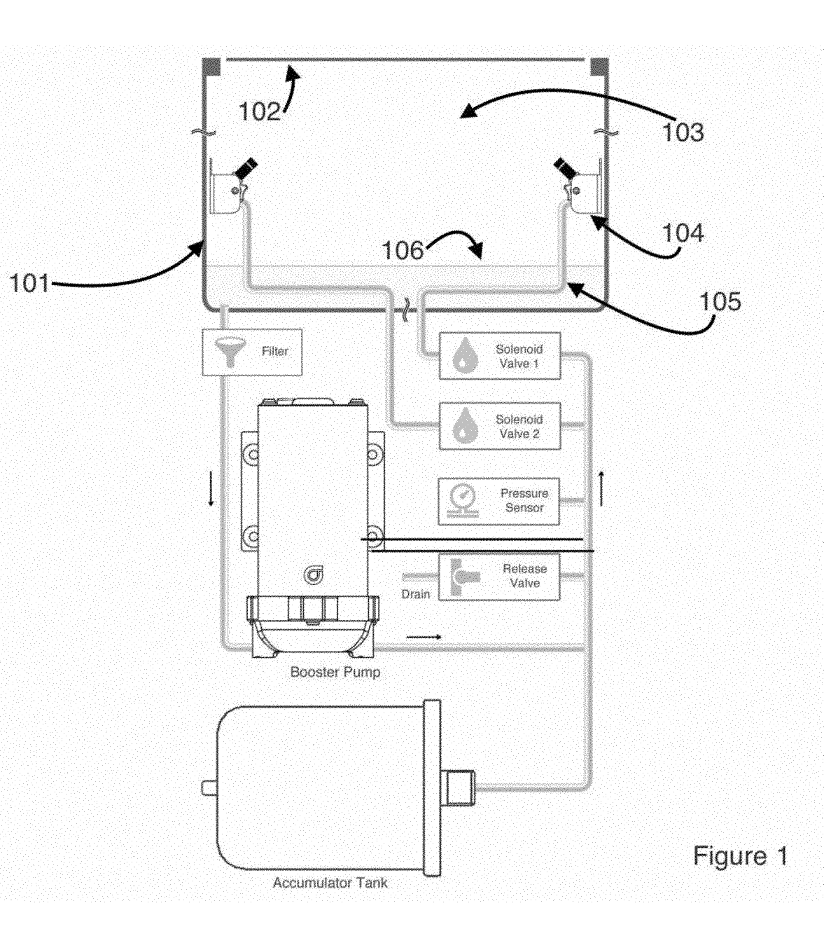

FIG. 1. illustrates a sample Opaque High-density EPP root chamber with a built-in reservoir in a typical high-pressure aeroponics system. The root chamber consists of container 101 and lid 102, both made of Opaque High-density EPP. Plant stems grow through holes on the lid 102. And roots are suspended in the root space 103. The atomizing nozzles 104 spray and deliver nutrients to root space 103. The nutrients were pushed through tube 105 by the high-pressure pump and accumulator tank, that draw from the reservoir 106.

The spray and air flow created by the atomizing nozzle 104 help blending and balancing temperatures of different zones in the root chamber.

The nutrients stored in the reservoir 106 act as heat capacitor, helping stabilizing the root chamber temperature.

Tube 105 is submerged in the reservoir to take advantage of heat capacity provided by the reservoir 106 so that the temperature of nutrients to be sprayed would be close the temperature of nutrient stored in the reservoir 106.

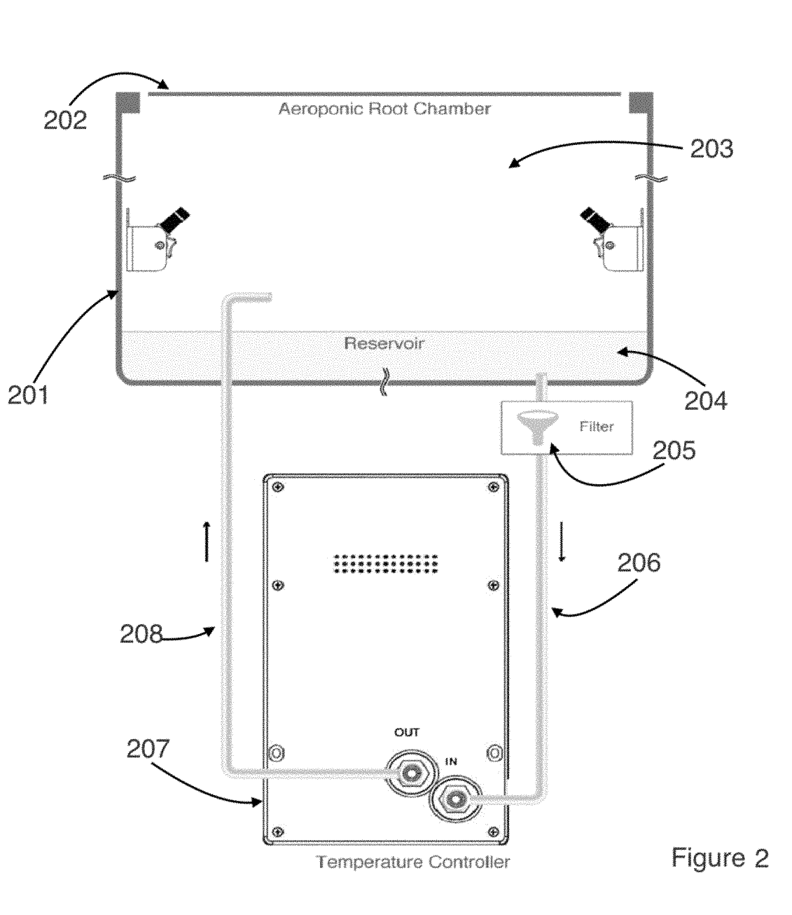

FIG. 2. illustrates a sample Opaque High-density EPP root chamber with active temperature controller 207. The root chamber consists of container 201 and lid 202, both made of Opaque High-density EPP. Plant stems grow through holes on the lid 202. And roots are suspended in the root space 203.

The sample root chamber includes bottom of the container 202 as a reservoir 204.

The nutrients in reservoir 204 are drawn throw filter 205, and through tube 206 into an active temperature controller 207 and back to reservoir 204 via tube 208. The cycling process cools or heats up the nutrients in reservoir 204 to reach the desired temperature, which is usually deviated from the temperature of surroundings.

Insulation by the EPP container 201 and lid 202 help shield the temperature inside of root chamber from outside influence and reduce the emerge used by temperature controller 207.

Having described my invention, I claim:

1. An enclosed chamber is made of opaque High-density EPP (Expanded Polypropylene) to host plant roots, and to provide thermal insulation and light blockage functions.

2. A chamber in claim 1, as a whole or portion, may be produced with molding process to create seamless body construction for better control of humidity, temperature, and liquid leakage.

3. A chamber in claim 1 may consist of multiple components, including leak-proof container portions, and/or separable lid portions.

4. A chamber in clam 1 may be completely or partially encapsulated.

5. Soft or hard linings may be used inside of a chamber in claim 1.

6. There may be outlets and inlets through the enclosure of a chamber in claim 1, for supplies such as nutrients to be delivered into, and wastes to drain out of the chamber.

7. A chamber in claim 1 may be in the shape of rectangular cube, cylinder, sphere, or other shapes.

8. A chamber in claim 1 may contain one or more optional nutrient reservoirs inside of the contained space, providing additional heat capacity and temperature stability.

9. One or more temperature control devices can work with a chamber in claim 1, to actively maintain desired root temperature, through temperature-controlled air flow, and/or liquids in reservoirs in claim 8.

10. To maximize the benefit of reservoir's heat capacity, the nutrient tubes adjunct to the spray nozzle(s) may be submerged in the reservoir, so that the nutrient in the tubes can reach the same temperature as of nutrient in the reservoir.

11. A chamber in claim 1 can also be used with deep-water hydroponics, where the plant roots grow directly inside one of more nutrient reservoirs in claim 8.
